(19) United States
(12) Patent Application Publication
(10) Pub. No.: US 2026/0225865 A1
(43) Pub. Date: Aug. 6, 2026

(54) TELESCOPIC BOOM AND CRANE

(71) Applicant: Liebherr-Werk Ehingen GmbH, Ehingen (DE)

(72) Inventors: Alexander SEELE, Ehingen (DE); Mario HELBIG, Ehingen (DE)

(21) Appl. No.: 19/459,648

(22) Filed: Jan. 26, 2026

(30) Foreign Application Priority Data
Jan. 29, 2025 (DE) 10 2025 103 128.2

(51) Int. Cl. B66C 23/82; B66C 23/70

(52) U.S. Cl. CPC B66C 23/82; B66C 23/701

(57) ABSTRACT

The present disclosure relates to a telescopic boom with a luffing element for luffing the telescopic boom, a base section and a support element, wherein the support element is arranged at least on the underside of the base section and has a mount configured for attaching the luffing element, wherein the telescopic boom has one or more, in particular two, bow elements which are arranged at least on the upper side of the base section and are connected to the support element such that the support element and the bow element or bow elements enclose the base section.

### CROSS REFERENCE TO RELATED APPLICATION

The present application claims priority to German Patent Application No. 10 2025 103 128.2 filed on January 29, 2025. The entire contents of the above-listed application are hereby incorporated by reference for all purposes.

### TECHNICAL FIELD

The present disclosure relates to a telescopic boom with a luffing element for luffing (pivoting) the telescopic boom, a base section, and a support element, wherein the support element is arranged at least on the underside of the base section and has a mount configured for attaching the luffing element.

### BACKGROUND

From JP 2010 126287 A, DE 102019110505 B3, and DE 102017110412 A1, such telescopic booms are known in the prior art.

### SUMMARY

In FIG. 6 and FIG. 7, by way of example, a crane 1000 in the form of a mobile crane is shown, which has an undercarriage 1010 and a superstructure 1020, which in turn comprises a telescopic boom 1021 and a turntable 1022.

To be able to raise (luff) the telescopic boom 1021, a luffing cylinder 1 connects the telescopic boom 1021 to the turntable 1022. The telescopic boom 1021 has a base section (German “Anlenkschuss”) with which the telescopic boom 1021 is hinged via a base articulation on the turntable 1022, and it has several telescoping sections that can telescope out from the base section.

In the crane shown in FIG. 6, a luffing cylinder 1 is arranged on each side of the base section. In the crane shown in FIG. 7, a single luffing cylinder 1 is arranged beneath the base section.

FIG. 8 illustrates that during operation of the crane 1000, a lifting load applied on the telescopic boom 1021 and its lever effect can generate very large forces on or in the luffing cylinder 1. To introduce these large forces into the telescopic boom 1021, a luffing cylinder box 2, which is implemented as a welded plate construction, is welded onto the boom. The luffing cylinder box 2 is also labeled in FIG. 6. The luffing cylinder 1 is articulated on the luffing cylinder box 2. Due to the lifting load being spaced from the turntable 1022, a load moment is produced in the telescopic boom 1021 which loads the telescopic boom 1021.

The telescopic boom 1021, which in cross-section is executed as an approximately circular cylinder, absorbs the resulting load moment via the compressive force 5 in the luffing cylinder 1 and the luffing cylinder box 2, as well as via an articulation in the form of a pin connection at the end of the telescopic boom 1021 to the turntable 1022.

For large cranes, a luffing cylinder 1 is mounted on each side of the luffing cylinder box 2 (or the telescopic boom 1021) in order to allow the largest possible cross-sectional area (height and width) for the telescopic boom 1021.

Depending on the position of the luffing cylinder(s) 1, the design of the luffing cylinder box 2 is adapted. FIG. 8 shows that the luffing cylinder 1 is positioned at an angle 74 to the telescopic boom 1021. The compressive force 5 can thus be resolved into a force along the telescopic boom 1021 and a force acting transverse to the telescopic boom 1021 along the vertical axis.

As is especially apparent from FIG. 9 and FIG. 11, the base section 7 of the telescopic boom 1021 has two side walls 4. The base section 7 is a telescopic boom profile of the telescopic boom 1021.

The compressive force 5 from each luffing cylinder 1 is introduced laterally into the base section 7 of the telescopic boom 1021.

The compressive force 5 of each luffing cylinder 1 is introduced via a respective lateral mount in the form of a pin mount and/or articulation, which together form a luffing cylinder mount 21 as shown in FIG. 9. Due to the compressive force 5 acting at an angle 74 to the longitudinal axis 71 of the base section 7 (as seen in FIG. 8), a torsional moment 51 about the vertical axes 52 is generated at the side walls 4 of the base section 7 (and thus the telescopic boom 1021), as depicted in FIG. 10 and FIG. 11.

As a result of the torsional moment 51, the base section 7 is subjected to a compressive load 41 and a tensile load 42, which are illustrated by arrows in FIG. 11. These loads 41 and 42 are absorbed by the side walls 4 of the base section 7. This absorption of loads 41 and 42 is enabled by a plate construction of the luffing cylinder box 2 that is optimized for force flow.

According to the prior art, various shapes of luffing cylinder boxes 2 are known, which as welded plate constructions form a kind of half-shell in which the base section 7 lies and which is connected almost all around to the base section 7 by weld seams 31, as is apparent from FIG. 9.

Depending on the position of the luffing cylinder mount 21 and the corresponding lifting load, the loading from compressive load 41, tensile load 42 and torsional moment 51 can lead to over-stressing of the base section 7.

The left cross-sectional view in FIG. 17 shows the cross-section of a telescopic boom of a smaller crane 1000 with only one luffing cylinder 1 connected via a luffing cylinder mount 21 centrally under the base section 7. Here, the compressive force 5 can be applied by only a single luffing cylinder 1. The other cross-sectional views in FIG. 17 show the solution for a crane 1000 with two luffing cylinder mounts 21 and thus two luffing cylinders 1. In this case, the compressive force 5 cannot be applied by just one luffing cylinder 1.

Depending on the crane, the introduction of force from the luffing cylinder(s) 1 or the luffing cylinder mount 21 is positioned differently.

The middle cross-sectional view in FIG. 17 shows the cross-section of a telescopic boom of a crane 1000, wherein two luffing cylinders 1 (and luffing cylinder mounts 21) are arranged laterally beneath the base section 7.

The right cross-sectional view in FIG. 17 shows the cross-section of a telescopic boom of a crane 1000, wherein two luffing cylinders 1 (and luffing cylinder mounts 21) are arranged laterally beside the base section 7.

FIGS. 12 to 15 show a base section of a telescopic boom from the prior art. This base section has a connecting element 8 for the attachment or articulation and/or connection of a Y-type bracing 9 (a spatial bracing of the telescopic boom). Such a base section additionally has a luffing cylinder box 2 for transmitting the compressive forces 5 of the luffing cylinders. The compressive forces 5 are not transmitted via the connecting element 8.

The connecting element 8 does not completely surround the base section. In the lower region of the base section, the connecting element 8 is not closed, as is apparent from FIG. 15. The force flow 92 for introducing the normal forces 91 of the Y bracing 9 runs only in a direction perpendicular to the base section, as shown in FIGS. 12–14. In contrast, the force flow of the compressive forces 5 at the luffing cylinder box 2 runs more in the longitudinal direction of the base section.

The connecting element 8 serves to absorb the normal forces 91 which act perpendicular to the longitudinal axis 71 of the base section.

When introducing the normal forces 91 via the Y bracing 9, no torsional moment is generated that could lead to large stresses in the less rigid areas of the base section.

In view of this background, the object of the present disclosure is to improve the above-mentioned telescopic boom, particularly with regard to improved introduction of forces from a luffing element into the base section or the telescopic boom.

This object is achieved by the subject matter described herein.

According to the disclosure, it is provided that the telescopic boom has one or more, for example two, bow elements which are arranged at least on the upper side of the base section and are connected to the support element, such that the support element and the bow element or bow elements enclose the base section.

Optionally, the support element is designed in the shape of a half-shell, whereby the support element partially encloses the base section in cross-section.

The base section optionally lies within the support element.

The support element and/or the bow elements optionally form a luffing cylinder box with lateral force introduction.

The support element and/or the bow elements optionally form a luffing cylinder box that encloses the base section.

Optionally, each bow element has two ends, and both ends of each bow element are arranged on the support element.

The support element can also be referred to as a luffing cylinder box.

The base section optionally has a top side, a bottom side, and two sides connecting the top and bottom. The top side can also be referred to as an upper wall, the bottom side as a lower wall, and the sides as side walls.

Optionally, the support element extends over at least a portion of the underside, in each case at least a portion of the sides, and/or at least a portion of the top side of the base section, and the bow element or one of the bow elements extends over the part of the base section that the support element does not extend over.

The support element and the bow element(s) optionally do not completely enclose the base section in the longitudinal direction. In the longitudinal direction, the support element optionally has a greater extent than the bow element(s).

It is conceivable that the support element also partially extends on the top side of the base section.

Optionally, in a given cross-section the support element extends over at least a portion of the underside and in that cross-section in each case at least a portion of the sides, and one of the bow elements in that cross-section extends over the part of the base section that the support element does not extend over.

Each “cross-section” is optionally a cross-sectional plane of the telescopic boom. A cross-section is optionally a cross-section perpendicular to the longitudinal axis of the base section.

Optionally, it is provided that the support element and one of the bow elements fully enclose the base section in one cross-section.

Optionally, it is provided that in another cross-section the support element extends over at least a portion of the underside and in that further cross-section and/or in the longitudinal direction of the base section over at least a portion of the sides, and another of the bow elements connects to the sections of the support element that extend in said further cross-section and/or in the longitudinal direction over at least a portion of the sides, and extends over the part of the base section that the support element does not extend over.

Optionally, none of the bow elements is directly connected (for example welded) to the base section, and none of the bow elements is completely connected (for example welded) to the base section, and in each case one or more gaps are present between the respective bow element and the base section.

Optionally, the support element has a further mount—which may be, for example, identical in construction to the aforementioned mount—configured for attaching a luffing element, wherein the support element is furthermore arranged at least partially on both sides of the base section and/or at least partially on the top side of the base section, such that one of the mounts is provided on one side of the base section on the support element and the other mount is provided on the other side of the base section on the support element. Each mount can be a pin-type mount.

Optionally, each bow element is either identical or different, and/or is of box-type construction, and/or has one elongated section and two shorter sections angled from it.

Optionally, both ends (for example the shorter sections) of each bow element are connected, for example welded, to the support element.

Optionally, several ribs—for example, ribs extending in the longitudinal direction of the base section and e.g. triangular in shape—are connected at the back and front to the support element (for example, welded), which ribs are also connected to the base section (for example, welded).

Optionally, the support element is of box-type construction and/or is fully or partially connected (for example, welded) to the base section.

Optionally, each mount is arranged in an upper quarter, fifth or sixth of the base section, optionally above a neutral axis 73 of the base section.

Optionally, the support element and each bow element consist of steel plate and are implemented as welded constructions.

The disclosure also relates to a crane, for example a mobile crane, having a telescopic boom according to the disclosure.

The crane, for example the mobile crane, optionally has a turntable, wherein the telescopic boom is hinged in a luffing manner to the turntable. The crane has a length-adjustable luffing element that has two ends, one end being articulated to a mount of the support element and the other end to the turntable, wherein the telescopic boom can be luffed (pivoted) relative to the turntable by changing the length of the luffing element.

Each luffing element is optionally a luffing cylinder, for example a hydraulic cylinder.

Optionally, the crane has an undercarriage, and the turntable is rotatably mounted on the undercarriage.

Optionally, the crane has a further length-adjustable luffing element, for example identical to the aforementioned luffing element, which has two ends, one end being articulated to a mount of the support element and the other end to the turntable, wherein the telescopic boom can be luffed relative to the turntable by changing the lengths of the luffing elements. One of the luffing elements is arranged on one side of the telescopic boom at a mount of the support element and the other luffing element on the other side of the telescopic boom at a mount of the support element.

It is noted that the terms “a” and “an” do not necessarily refer to exactly one of the elements (although this is one possible embodiment), but can also denote a plurality of the elements. Likewise, the use of the plural also includes the presence of the element in the singular, and vice versa the singular encompasses multiple instances of the element. Furthermore, all features of the disclosure described herein can be combined with one another arbitrarily or claimed independently of one another.

### BRIEF DESCRIPTION OF THE FIGURES

Further advantages, features and effects of the present disclosure will become apparent from the following description of preferred exemplary embodiments with reference to the figures, in which identical or similar components are designated by the same reference numerals. In the figures, the following are shown:

FIG. 1: a cross-sectional view of a telescopic boom from the prior art and a cross-sectional view of one embodiment of a telescopic boom according to the disclosure.

FIG. 2: a perspective view of one embodiment of a telescopic boom according to the disclosure.

FIG. 3: a perspective view of one embodiment of a telescopic boom according to the disclosure.

FIG. 4: a cross-sectional view of one embodiment of a telescopic boom according to the disclosure.

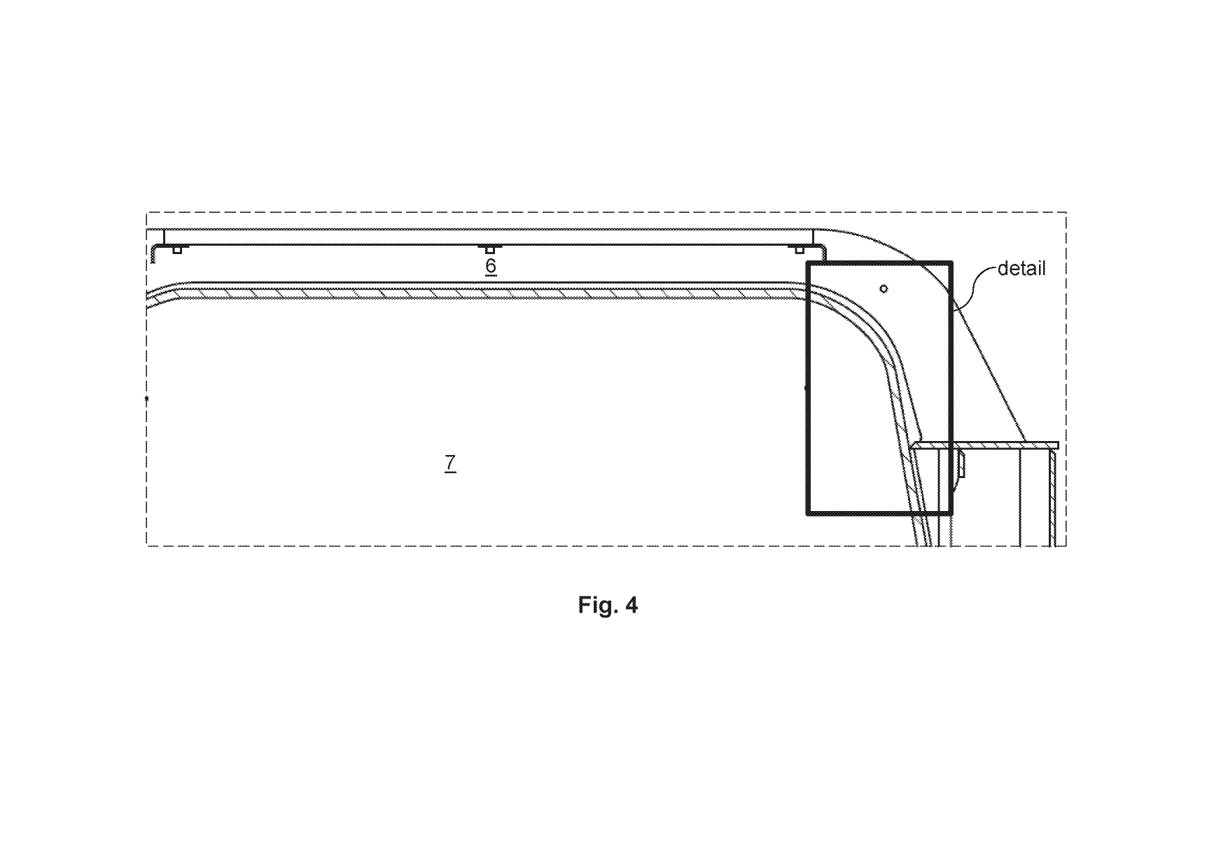

FIG. 5: a detail of the cross-sectional view of FIG. 4.

FIG. 6: a perspective view of a crane from the prior art.

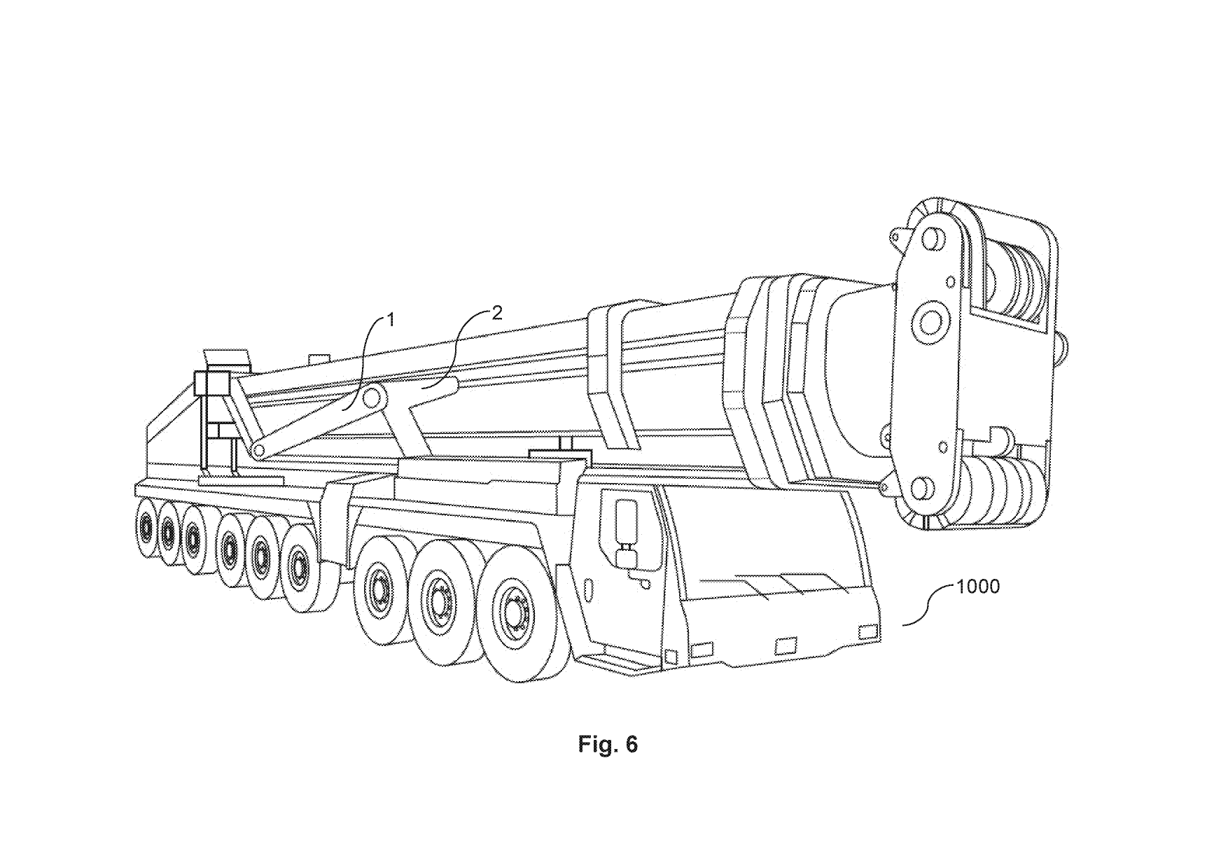

FIG. 7: a side view of a crane from the prior art.

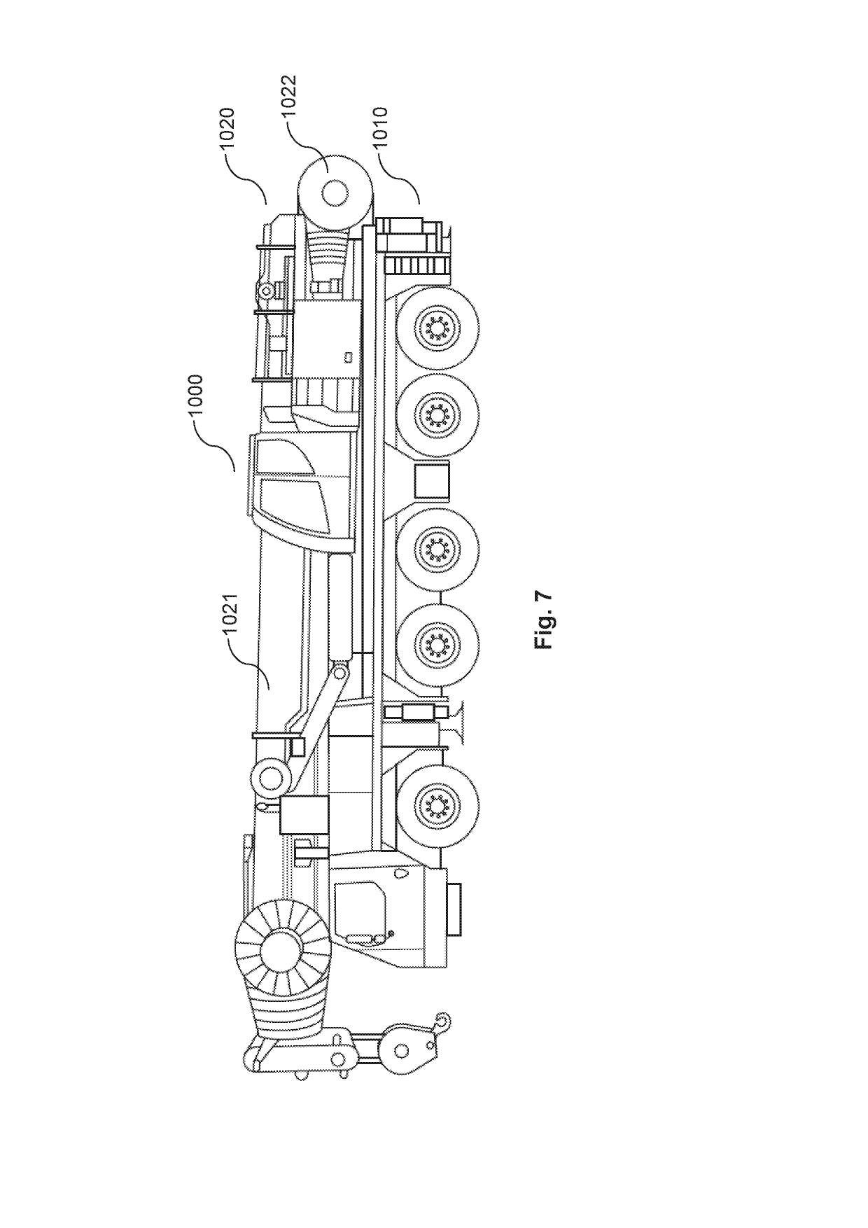

FIG. 8: a schematic view of components of a crane from the prior art.

FIG. 9: a perspective view of a telescopic boom from the prior art.

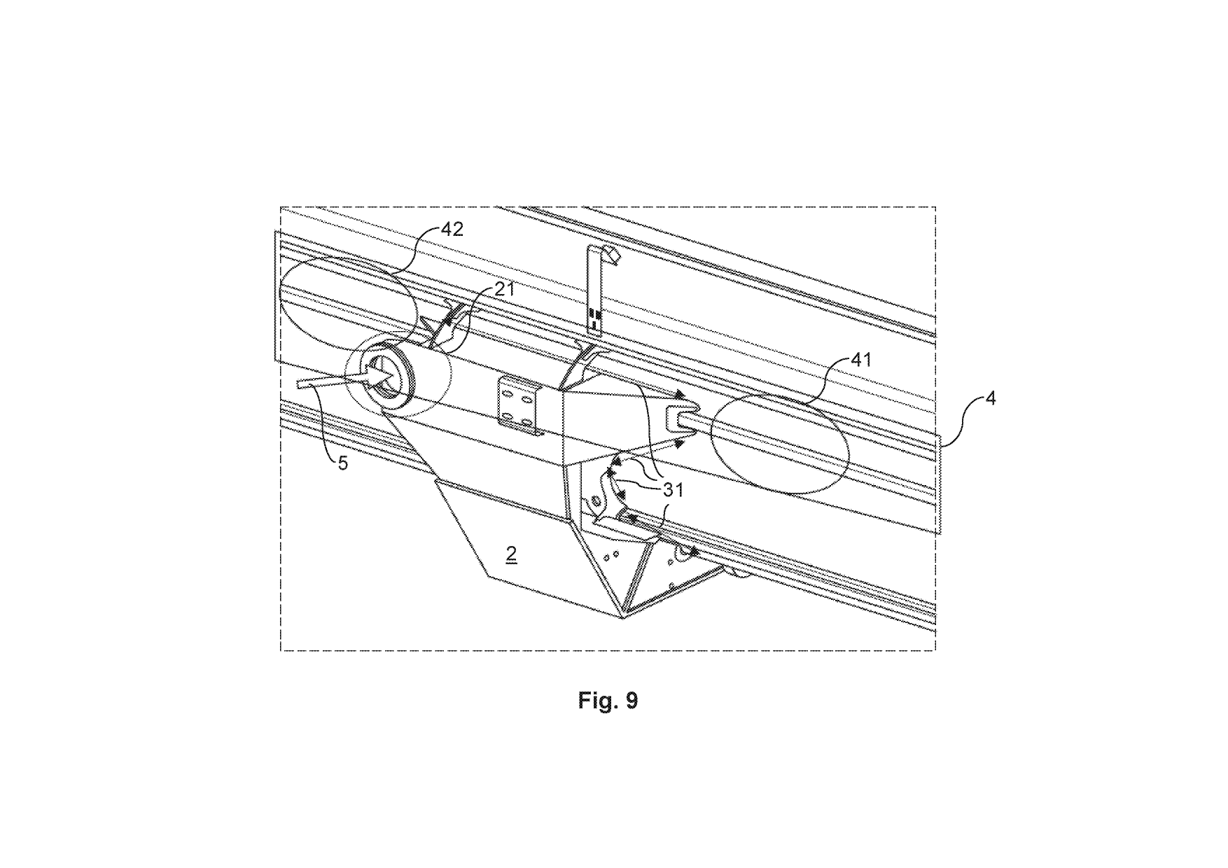

FIG. 10: a top view of a telescopic boom from the prior art.

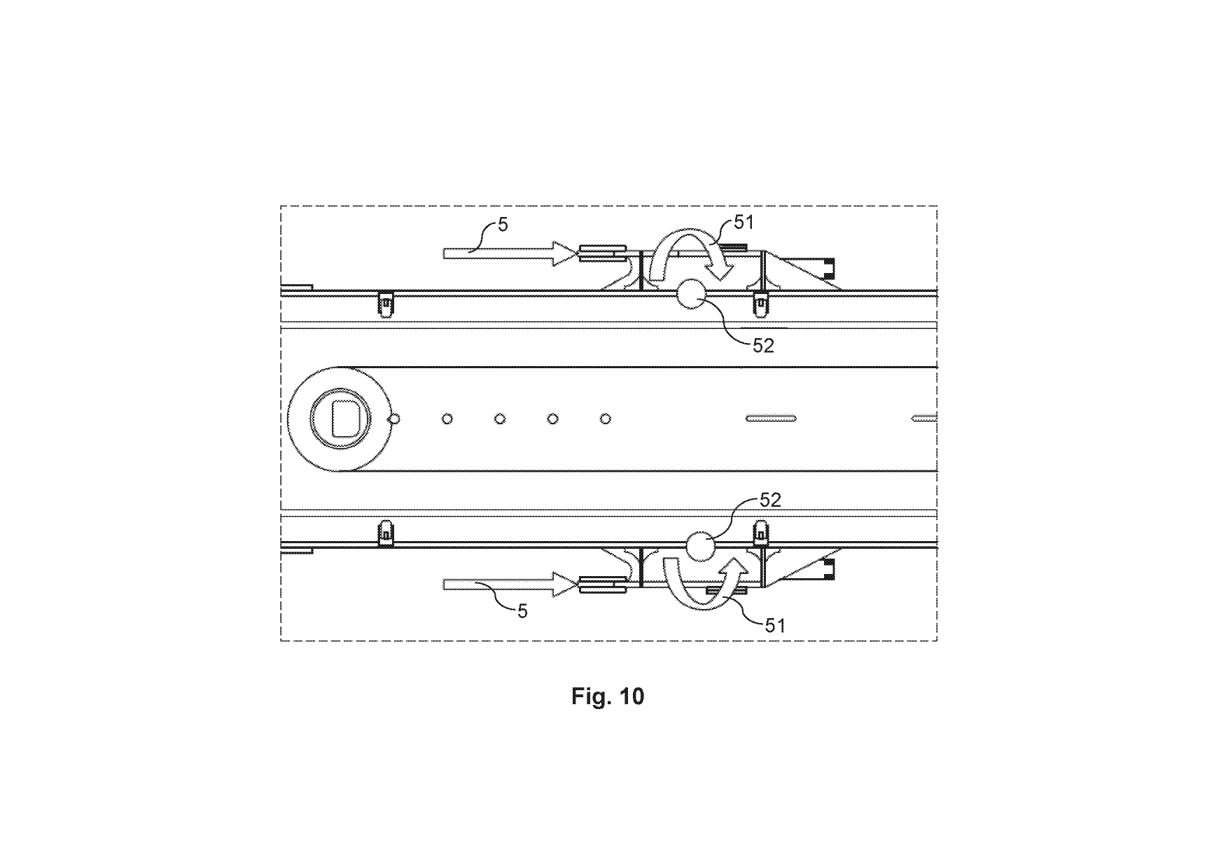

FIG. 11: a perspective view of a telescopic boom from the prior art.

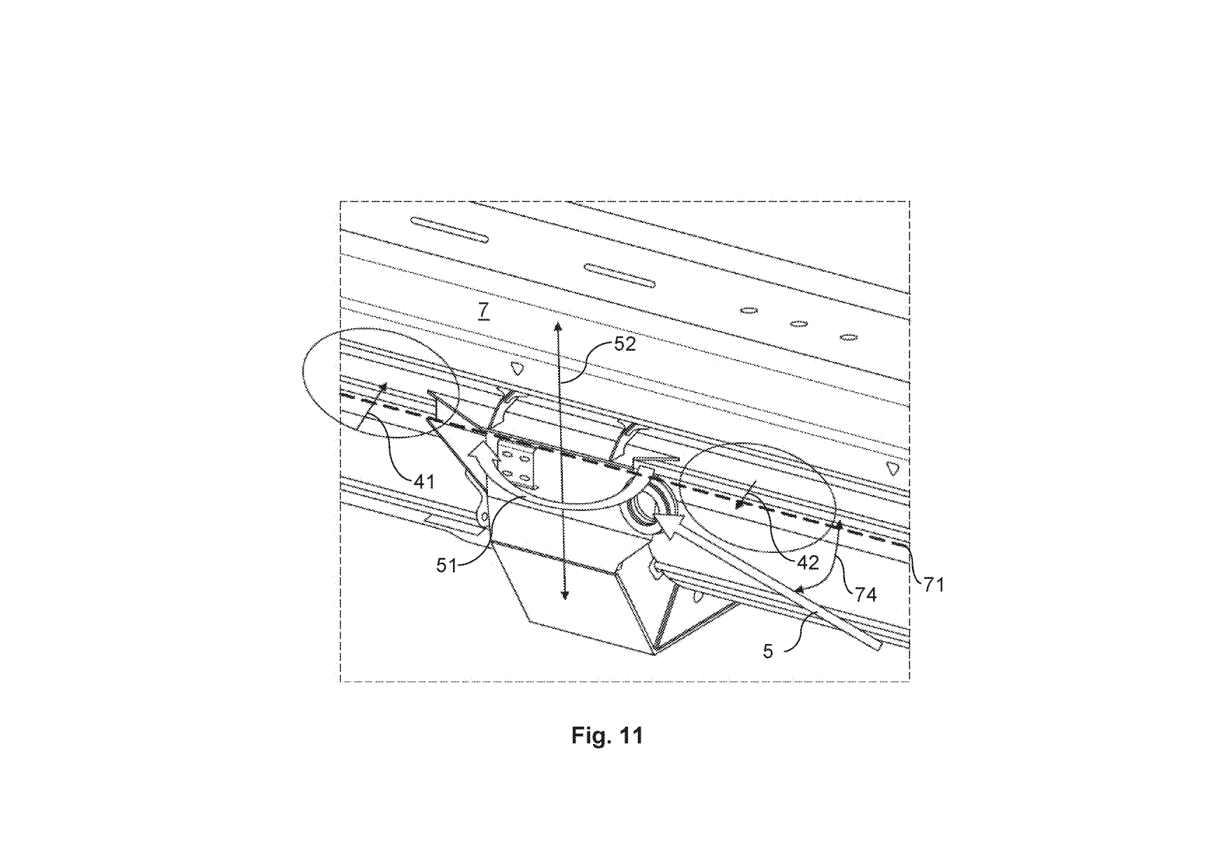

FIG. 12: a perspective view of a telescopic boom from the prior art.

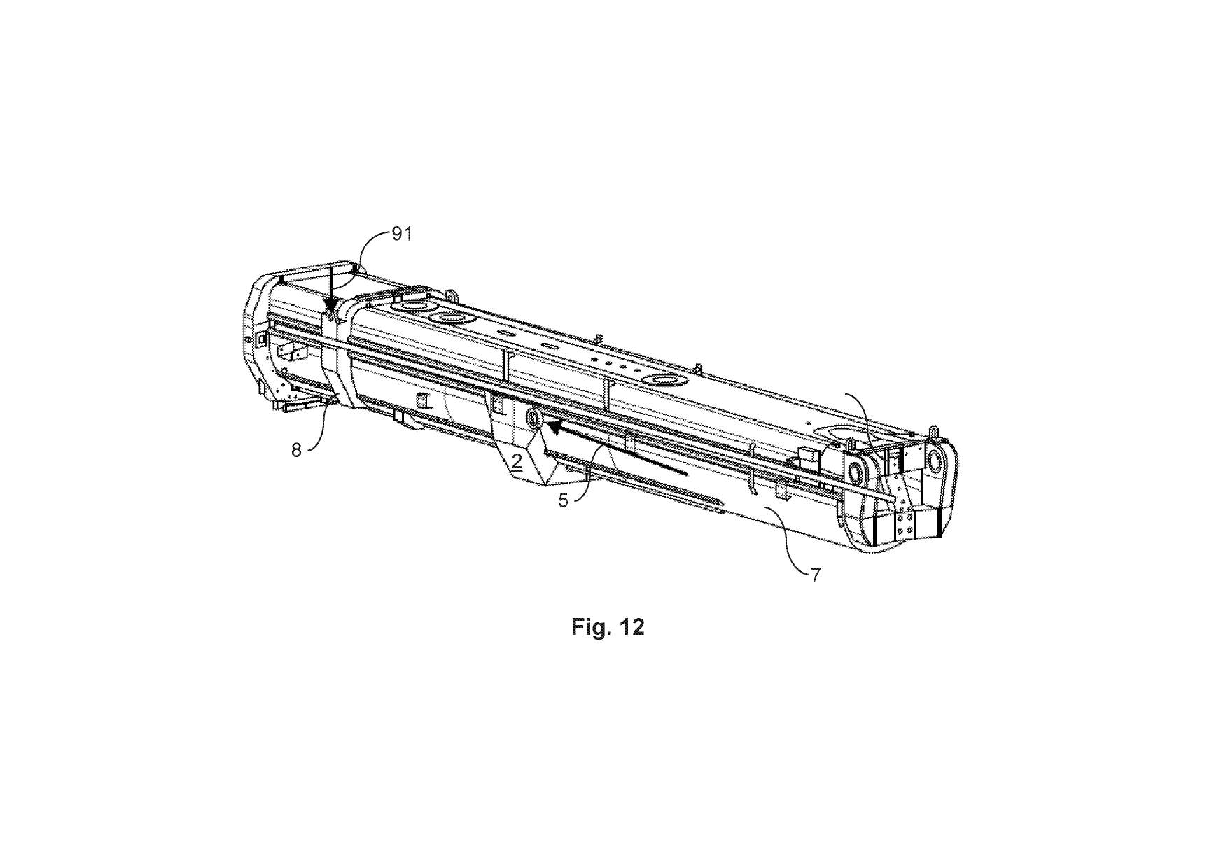

FIG. 13: a perspective view of a telescopic boom from the prior art.

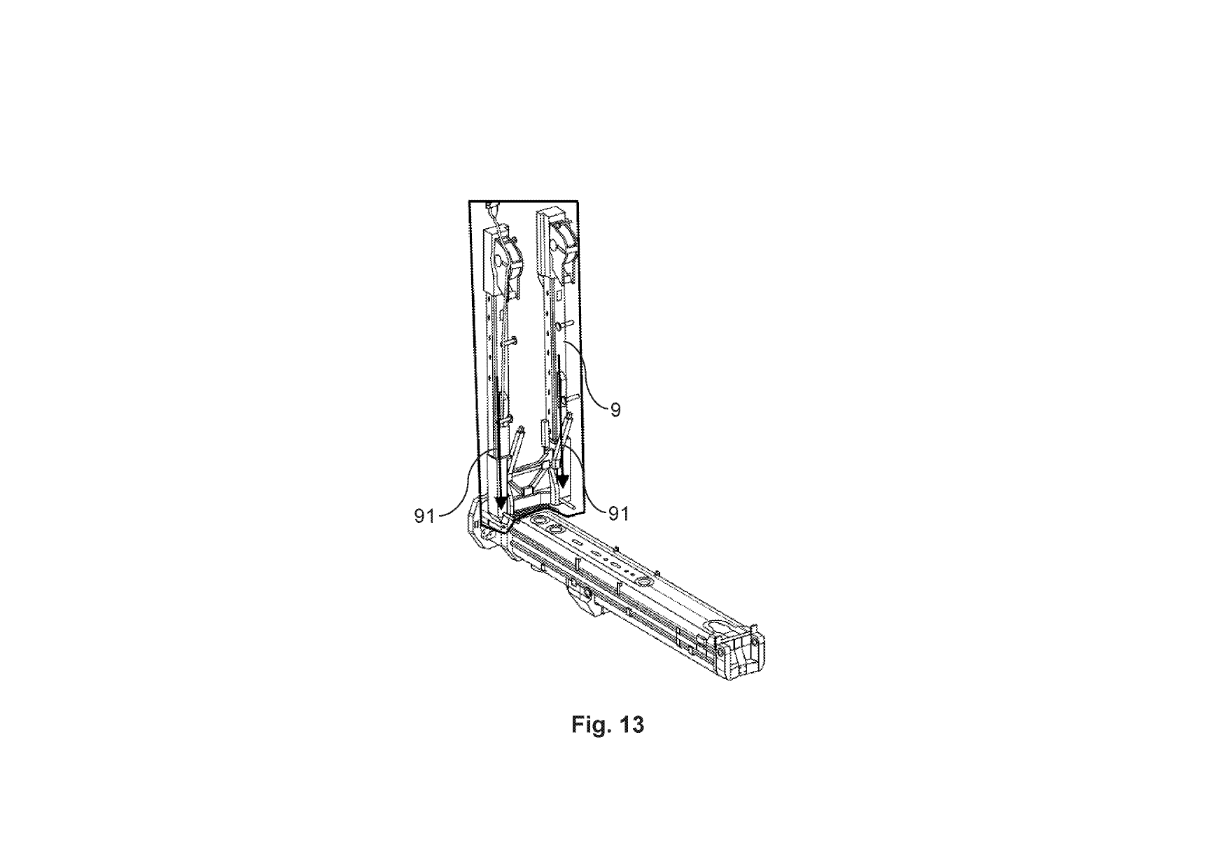

FIG. 14: a perspective sectional view of a telescopic boom from the prior art.

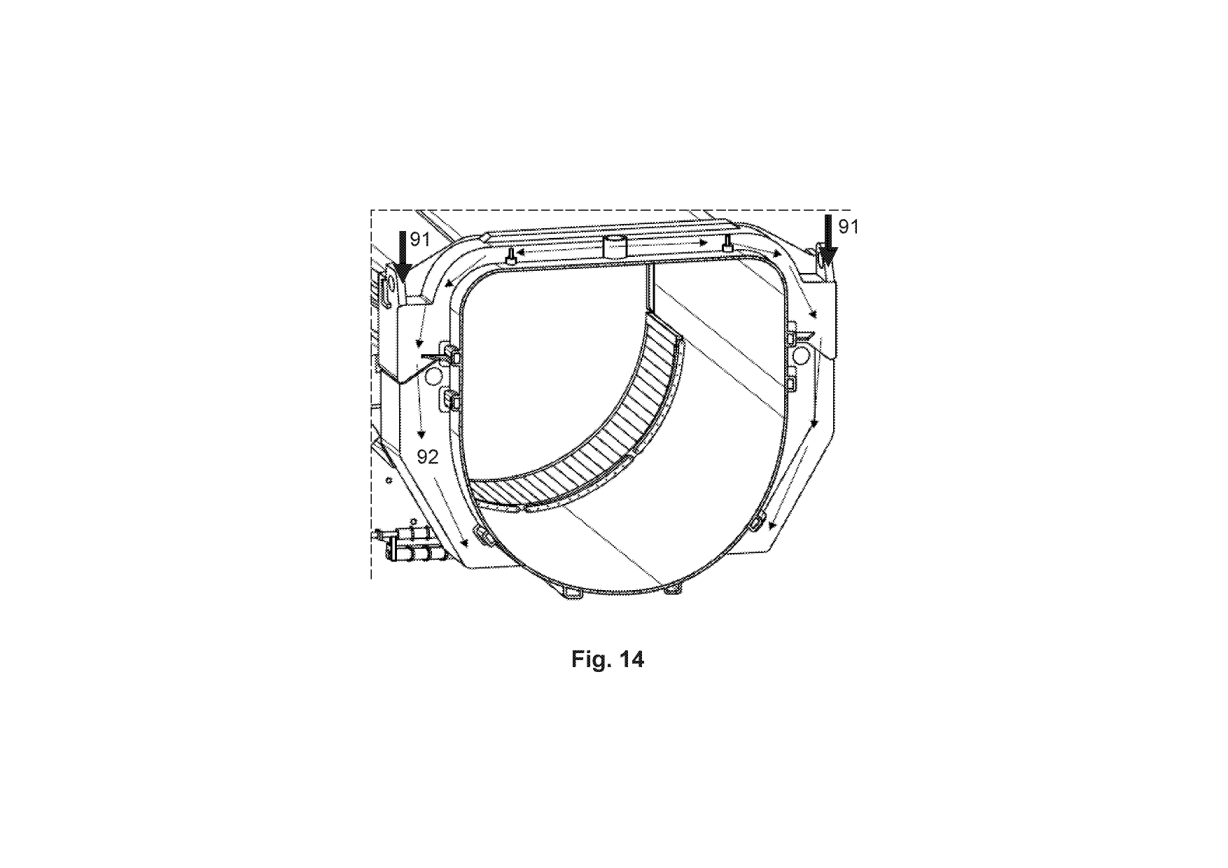

FIG. 15: a perspective sectional view of a telescopic boom from the prior art.

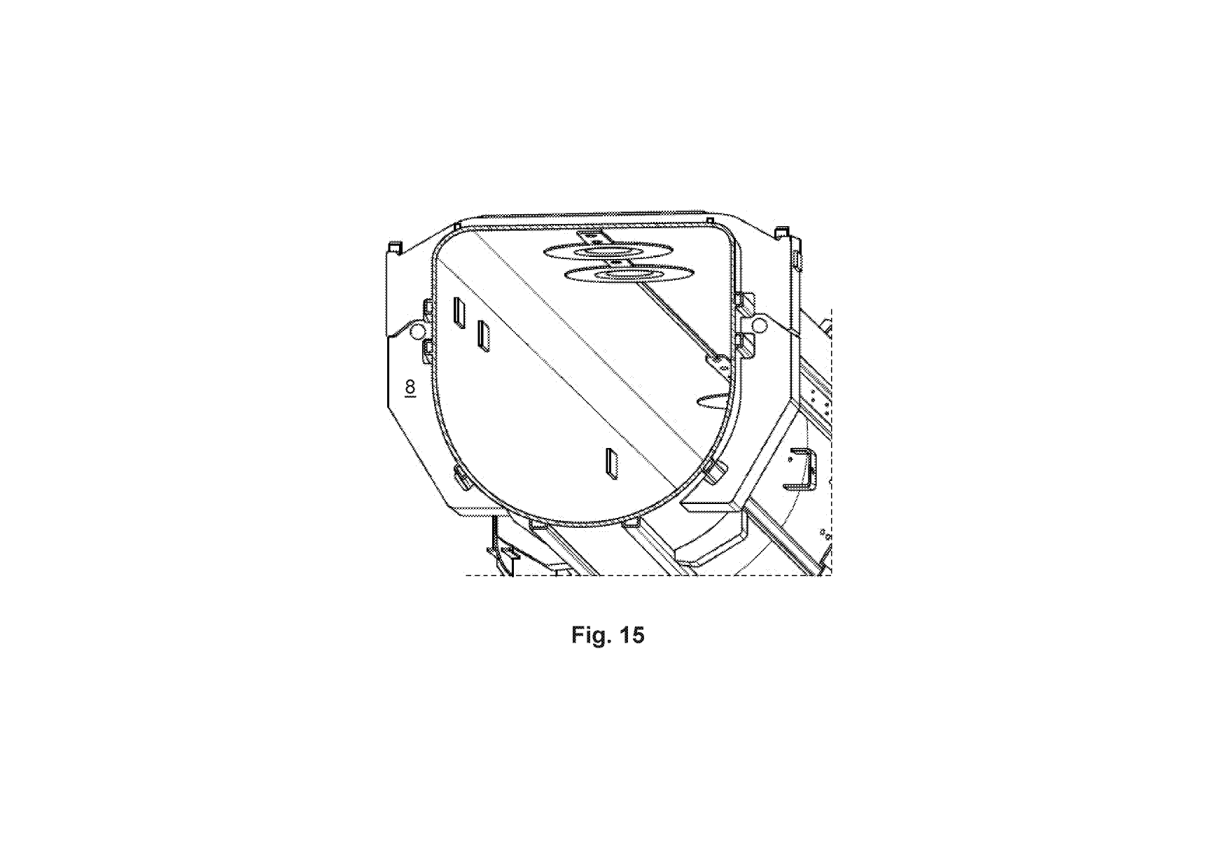

FIG. 16: a perspective sectional view of a telescopic boom from the prior art.

FIG. 17: three cross-sectional views of telescopic booms from the prior art.

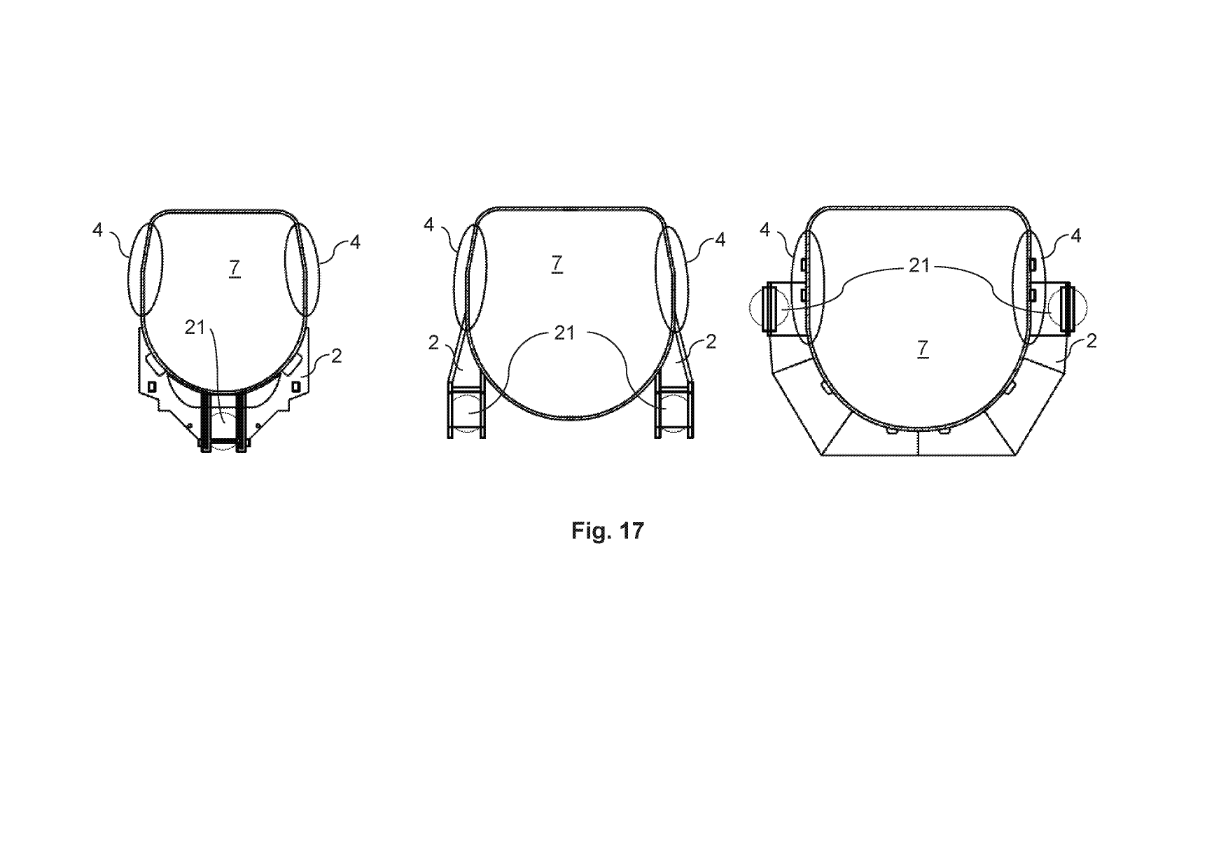

FIG. 18: a schematic view of a telescopic boom from the prior art.

### DETAILED DESCRIPTION

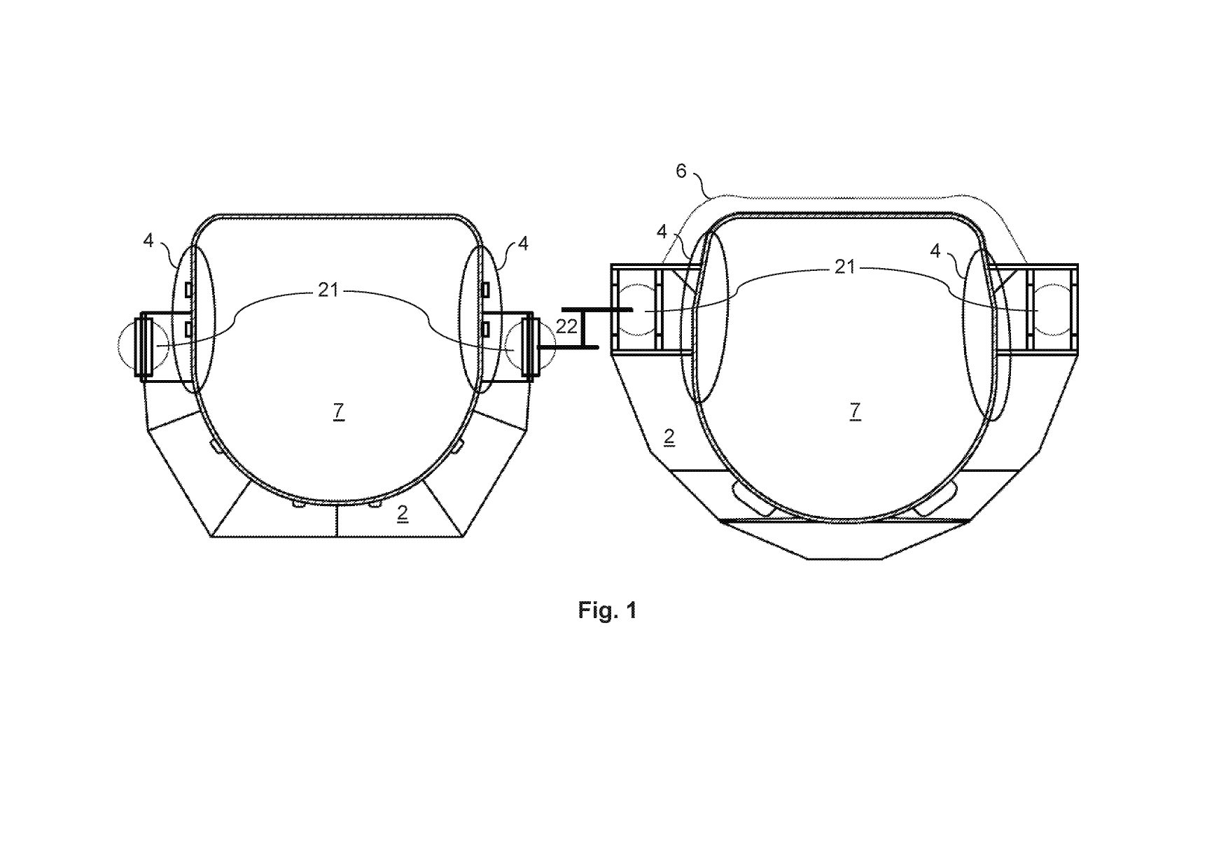

In FIG. 1, on the right, a cross-section of a telescopic boom is shown with a base section 7 and a support element in the form of a luffing cylinder box 2 that has two luffing cylinder mounts 21, wherein the luffing cylinder box 2 in cross-section extends over the underside and over a portion of each of the side walls 4 of the base section 7.

At the top side of the base section 7, a bow-shaped arch 6 (German: “Bügelelement”) is arranged. In cross-section, the arch 6 extends over the top side of the base section 7 and over a portion of each of the side walls 4 of the base section 7, and is connected on both sides to the luffing cylinder box 2.

The luffing cylinder box 2 and one or more arches 6 enclose the base section 7.

The luffing cylinder box 2 and/or the arch(es) 6 are implemented as welded plate constructions.

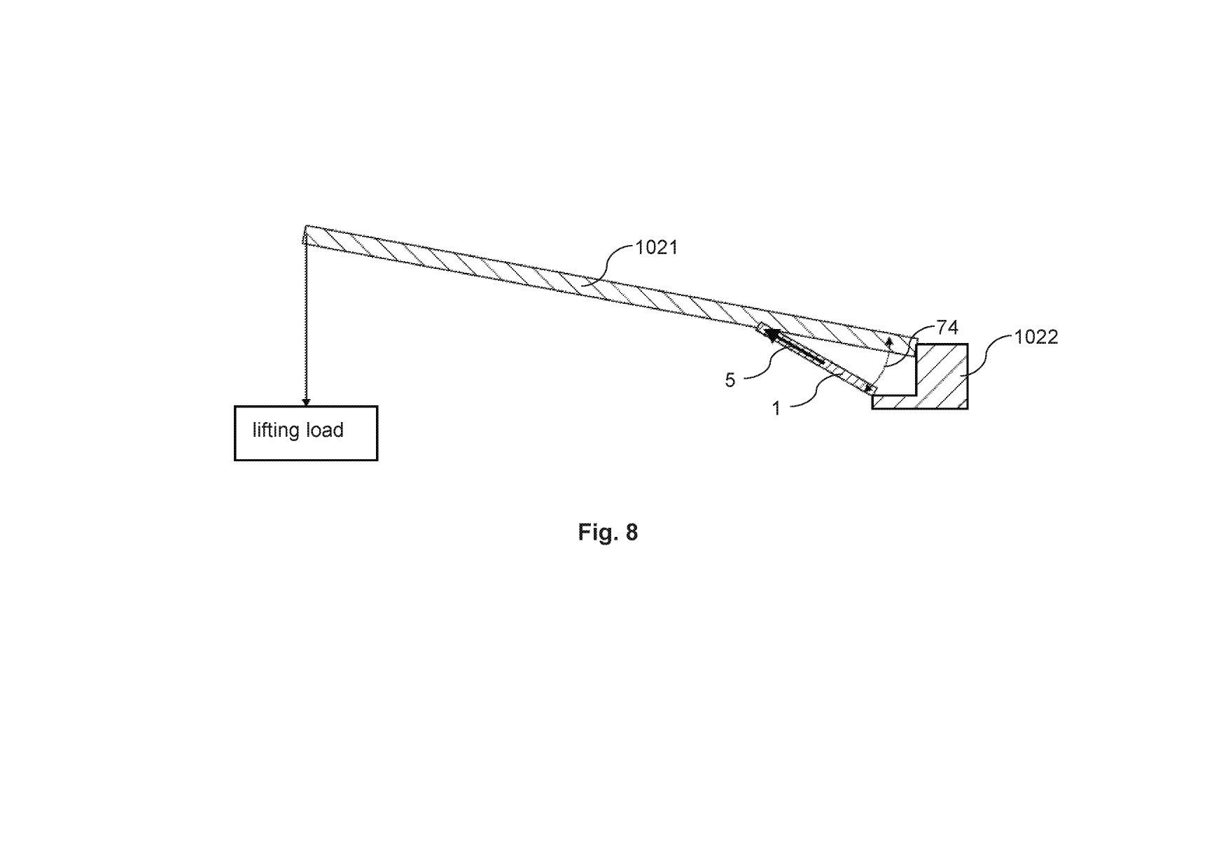

To minimize the compressive forces 5 in the luffing cylinder 1, the luffing cylinder mount 21 of the luffing cylinder is positioned as high as possible on the side wall 4. As a result, a favorable angle 74 is obtained between the line of action of the luffing cylinder 1 and the longitudinal axis 71 of the base section 7, as shown in FIG. 8.

This favorable angle 74 reduces the necessary compressive forces 5 during crane operation and thus allows a more slender design of the luffing cylinder 1.

The base section 7 has less stiffness in the region of the side wall 4 against forces acting transverse to the side wall 4 than in regions above or below.

In FIG. 1, on the left, a cross-section of a prior-art telescopic boom with a base section 7 and a support element in the form of a luffing cylinder box 2 that has two luffing cylinder mounts 21 is shown.

In the embodiment of the telescopic boom according to the disclosure, the luffing cylinder mounts 21 have been shifted upward compared to the prior-art telescopic boom. As is clear from FIG. 1, a vertical offset 22 results. This further optimizes the angle 74 (see FIG. 8) and the compressive force 5 can be kept small.

In particular to increase the load capacity of the telescopic boom with the lowest possible weight, one, two or more arches 6 are arranged above the base section 7.

The base section 7 can have any cross-sectional profile.

The base section optoinally has the shape of a cylindrical shell in one region of a cross-section, and in at least one cross-section is enclosed by the luffing cylinder box 2 and an arch 6.

Without the arch or arches, the luffing cylinder box would have to be made correspondingly massive to absorb the resulting compressive load 41 and tensile load 42 from the torsional moment 51 of the compressive force 5 in the side wall 4, and to compensate for the lack of stiffness against loads perpendicular to the side wall 4 of the base section 7. This could not be achieved at an economically feasible steel weight.

The luffing cylinder box 2 optionally takes up compressive forces 5 primarily along the longitudinal axis 71 of the base section 7 (e.g. the boom) and transmits them into the base section 7. The transverse loads in compression 41 and tension 42 resulting from the compressive load and the resulting torsional moment are absorbed by the arches 6.

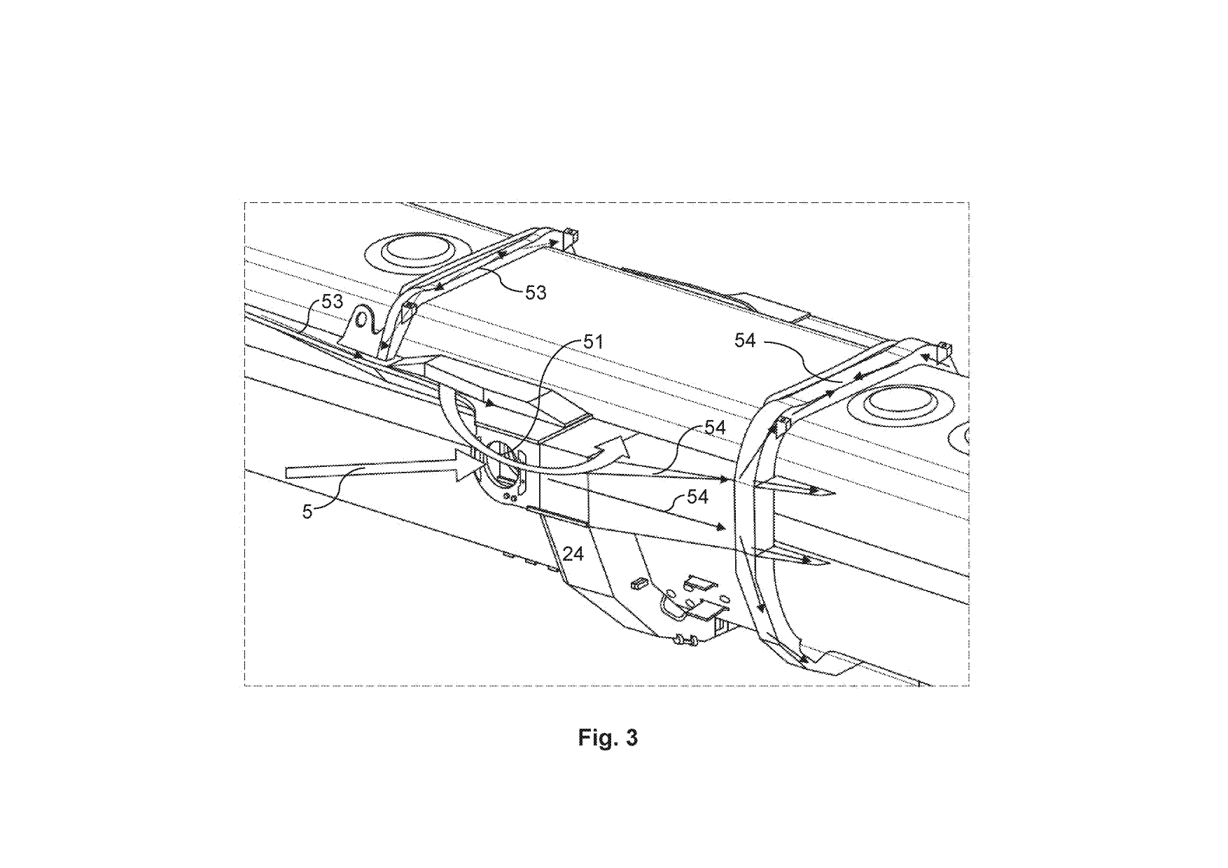

As explained above, the torsional moment 51 gives rise to tensile force loads 53 and compressive force loads 54, as shown in FIG. 3.

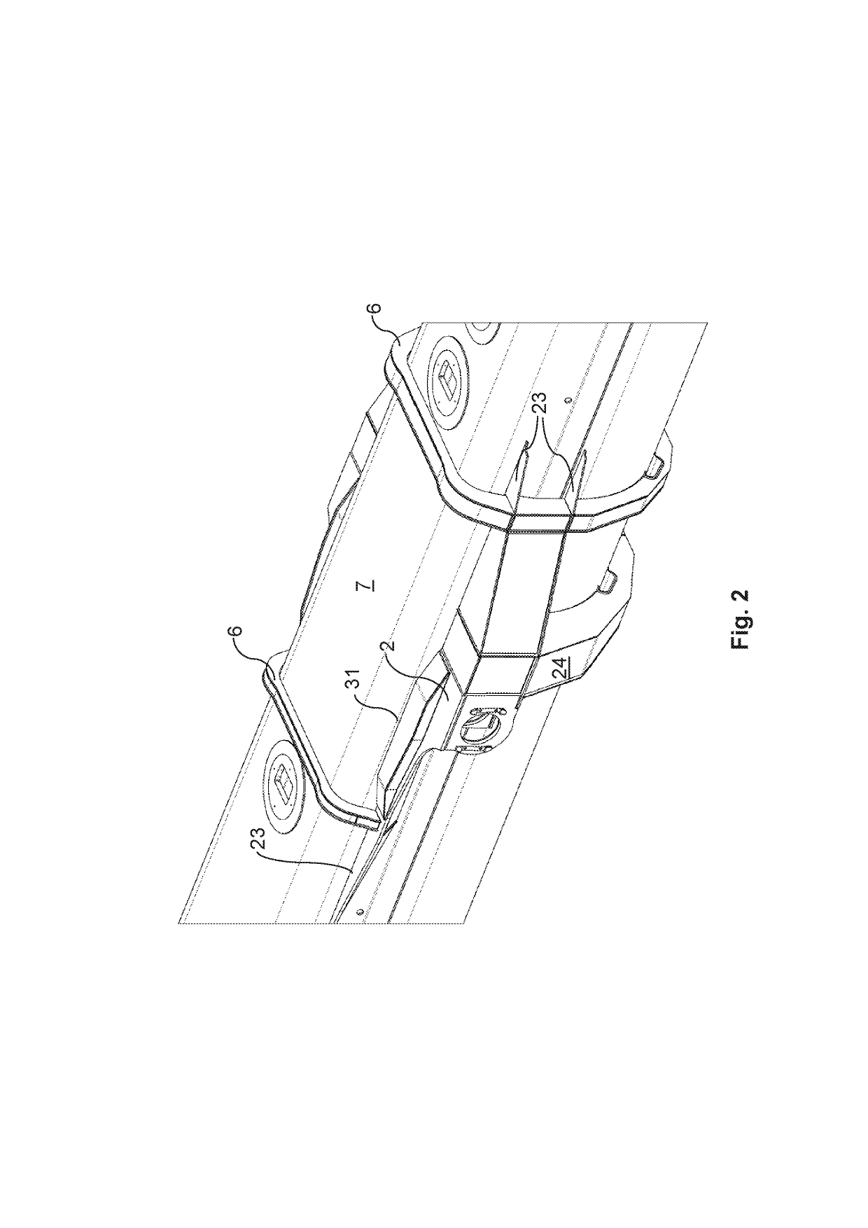

Via the luffing cylinder box 2, tensile forces 53 and compressive forces 54 are introduced into the arches 6 and into ribs 23 attached to the base section 7 by weld seams 31 (these ribs are shown in FIG. 2 and FIG. 3). Through the arches 6, the tensile and compressive forces 42 and 41, which result from the compressive force 5 and thus from the torsional moment 51, are shunted (short-circuited) without overloading the base section 7. Thus compressive loads 54 and tensile loads 53 occur in the arch 6.

As shown in FIG. 2 and FIG. 3, the luffing cylinder box 2 has two half-shells that partially enclose the base section 7 in a lower region, and two longitudinal elements on each side of the base section 7 extending in the longitudinal direction of the base section 7. In each of the longitudinal elements, a luffing cylinder mount 21 is integrated. The rear half-shell 24 is wider than the front half-shell. The rear arch and the front arch 6 are arranged at a certain distance from the vertical axis 52 in order to minimize the compressive loads 54 and tensile loads 53 in the arches 6 by means of a larger lever arm.

The front half-shell is followed by the front arch 6. The front arch 6 has the same width as the front half-shell.

The front half-shell and the front arch 6 fully enclose the base section 7 in one cross-section.

The longitudinal elements extend further to the rear than the rear half-shell 24. The rear arch 6 adjoins the portion of each longitudinal element that lies behind the rear half-shell 24.

In the rear area of the luffing cylinder box 2, due to the space required by the luffing cylinder 1, a continuous encircling configuration of the luffing cylinder box 2 and the rear arch 6 in a single cross-section is not possible. The function of a structure encircling the base section 7 in one cross-section is assumed by the rear half-shell 24 of the luffing cylinder box 2 below the luffing cylinder mount 21, the rear arch 6, and the sections of the two longitudinal elements that lie between the rear half-shell 24 and the rear arch 6.

The rear arch 6 shunts (short-circuits) the tensile load 42 in the side wall 4 and therefore experiences tensile forces 53. The front arch 6 shunts the compressive load 41 in the side wall 4 and therefore experiences compressive forces 54.

With respect to the base section, the terms “rear” and “front” are used such that “rear” denotes the direction of the articulation via which the base section can be hinged to, for example, a crane, and “front” denotes the opposite direction. Likewise, “top” and “bottom” refer to orientations that are present when the telescopic boom is in its intended use (for example, when the telescopic boom is mounted on a crane and in the transport position).

Without the two arches 6, the base section 7 would experience a significantly higher load.

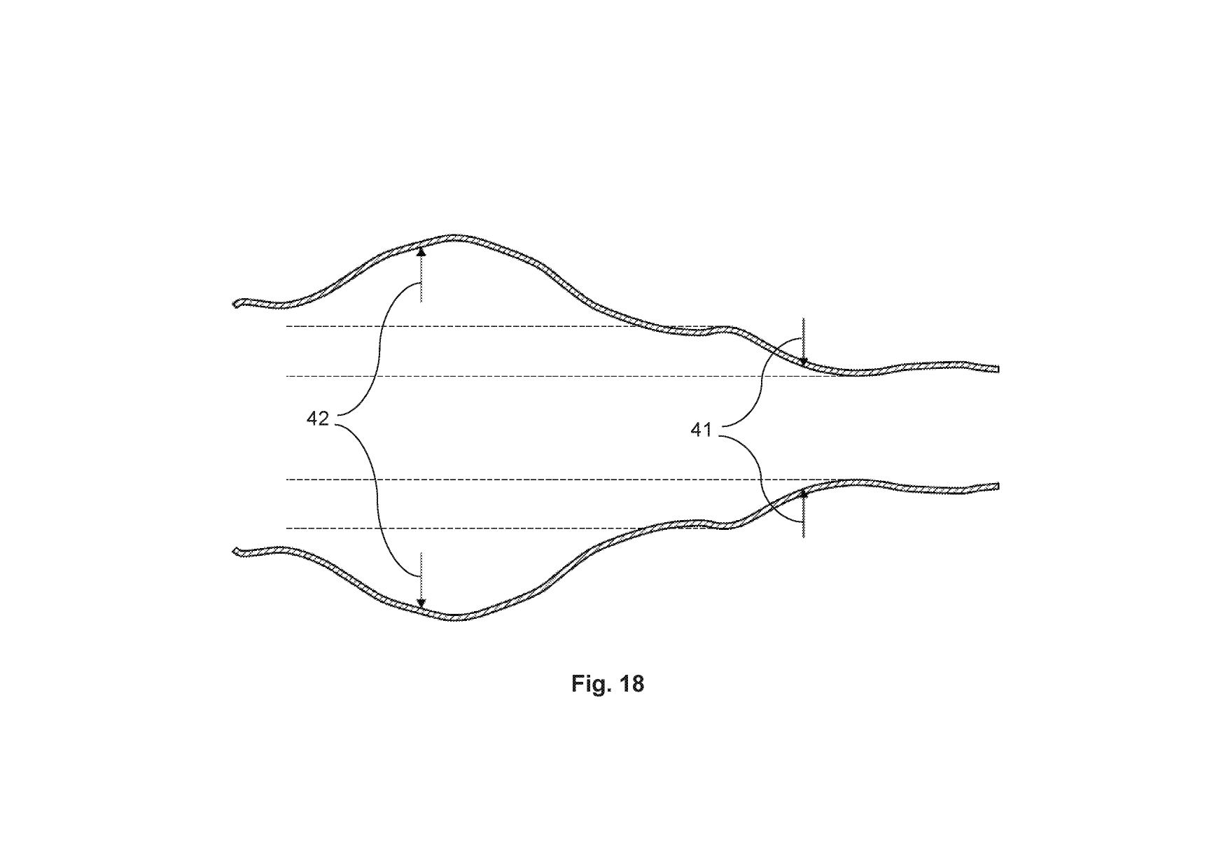

FIG. 18 shows, greatly exaggerated for illustrative purposes, the expected deformation of a prior-art base section 7 without an arch 6 due to the compressive load 41 and tensile load 42, which are symbolized by arrows in FIG. 18.

The force flow of the compressive force 5 in the luffing cylinder 1 has been optimized and the loading has been split such that both the arch 6 and the base section 7 absorb loads and shunt them to the opposite side.

In the rear area of the base section 7, the enclosure is formed by the large half-shell 24 of the luffing cylinder box 2 below the luffing cylinder mount 21, the sections of the two longitudinal elements that run between the rear half-shell 24 and the rear arch 6 in the longitudinal direction, and the rear arch 6, as shown in FIG. 3.

The enclosure can thus be provided, for example in ring-like fashion, in one cross-section or also extending over multiple cross-sections, whereby the enclosure partially extends in the longitudinal direction of the base section 7.

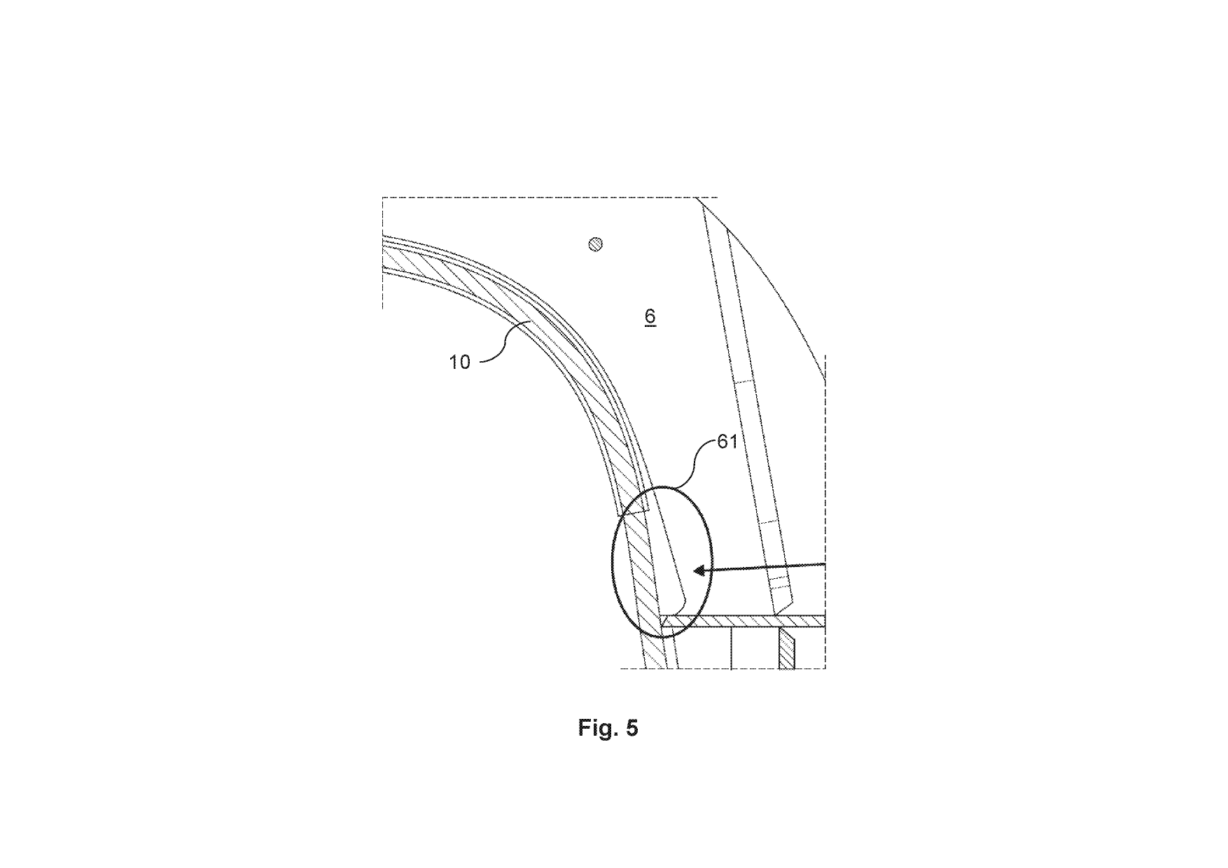

The arches 6 are not connected to the base section 7 (for example are not welded to the base section 7). A gap 61 is present across the entire width between each arch 6 and the base section 7, as shown in FIG. 5. This avoids the negative influences of welding distortion on the shape and dimensional accuracy of the base section 7. Likewise, no notch or microstructural change is produced in the area 10 of the base section 7 (marked in FIG. 5) that is highly stressed by tensile stress.

It is conceivable that without an arch enclosing the base section, the compressive forces 5 arising during operation of the crane with the given position of the luffing cylinder mount 21 could not be introduced, or only with significantly higher use of material and thus weight.

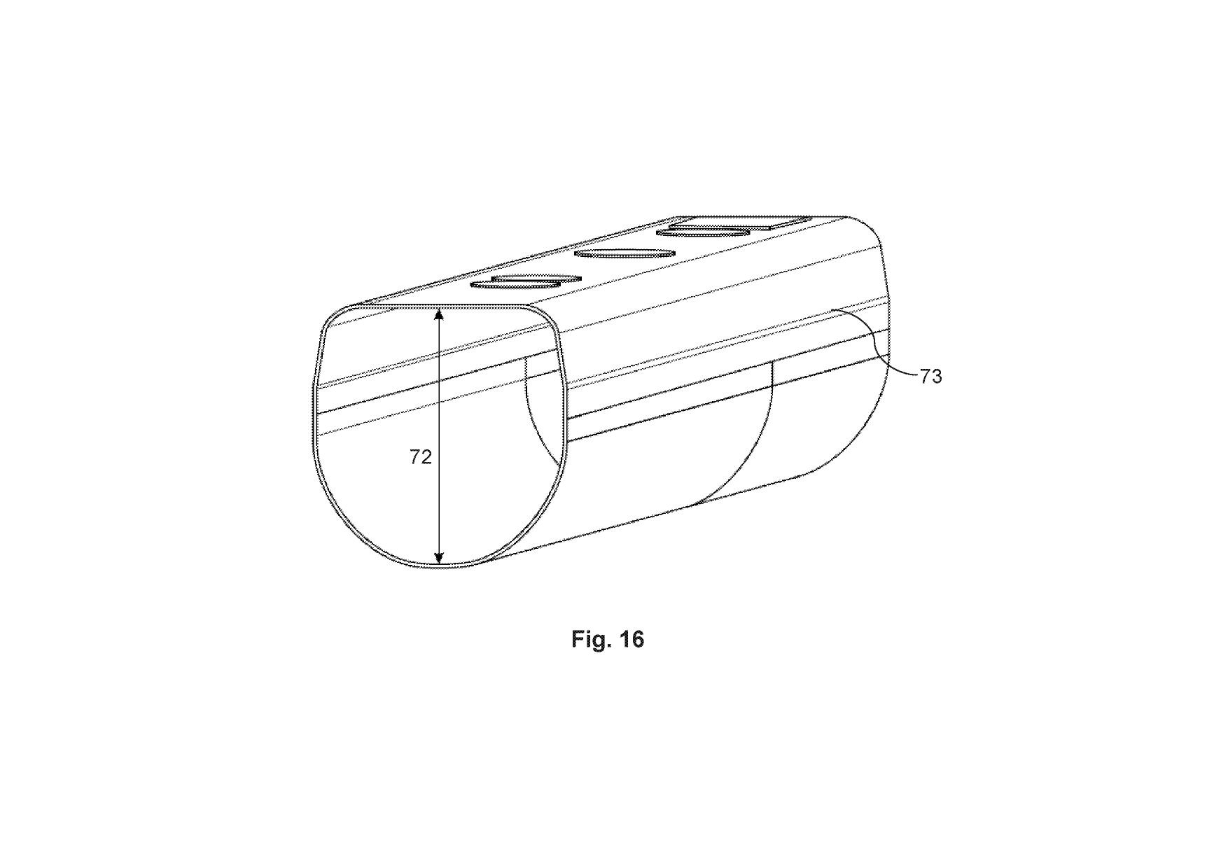

FIG. 16 shows the influence of the vertical offset 22 of the luffing cylinder mount 21 for attaching the luffing cylinder 1 on the base section 7, on the loads of the base section 7. In FIG. 16, no arch is provided on the base section 7.

In FIG. 16, the height 72 of the base section 7 and its neutral axis 73 during bending are depicted.

### LIST OF REFERENCE SIGNS

1000: Crane

1010: Undercarriage

1020: Superstructure

1021: Telescopic boom

1022: Turntable

1: Luffing cylinder

2: Luffing cylinder box

21: Luffing cylinder mount

22: Vertical offset of the luffing cylinder mount

23: Ribs for load introduction on the luffing cylinder box

24: Half-shell

31: Weld seams between base section and luffing cylinder box

4: Side wall of the base section

41: Compressive region on the side wall

42: Tensile region on the side wall

5: Compressive force (in particular generated by the luffing cylinder)

51: Torsional moment acting on the side wall of the base section

52: Vertical axis about which the torsional moment acts

53: Tensile force in the rear arch

54: Compressive force in the front arch

6: Arch (Bügel)

61: Gap between arch and base section

7: Base section (Anlenkschuss)

71: Longitudinal axis of the base section

72: Height of the base section

73: Neutral axis of the base section (with respect to bending)

74: Angle between the luffing cylinder’s line of action and the base section’s longitudinal axis

8: Connecting element of the Y bracing

9:Y bracing (spatial boom bracing)

91: Normal force from load via Y bracing

92: Force flow in the connecting element of the Y bracing

10:Area highly stressed by tensile stress

1. A telescopic boom, with a luffing element for luffing the telescopic boom, a base section, and a support element, wherein the support element is arranged at least on the underside of the base section and has a mount configured for attaching the luffing element, wherein the telescopic boom comprises one or more bow elements which are arranged at least on the upper side of the base section and are connected to the support element, such that the support element and the one or more bow elements enclose the base section.

2. The telescopic boom according to claim 1, wherein the support element extends over at least a portion of the underside, in each case at least a portion of the sides, and/or at least a portion of the upper side of the base section, and at least one of the one or more bow elements extends over a part of the base section that the support element does not extend over.

3. The telescopic boom according to claim 1, wherein the support element in a cross-section extends over at least a portion of the underside, in that cross-section in each case at least a portion of the sides, and one of the one or more bow elements in that cross-section extends over a part of the base section that the support element does not extend over.

4. The telescopic boom according to claim 3, wherein the support element in another cross-section extends over at least a portion of the underside and in that further cross-section and/or in the longitudinal direction of the base section over at least a portion of the sides, and a bow element of the one or more bow elements adjoins the sections of the support element that extend in said further cross-section and/or in the longitudinal direction over at least a portion of the sides, and extends over the part of the base section that the support element does not extend over.

5. The telescopic boom according to claim 1, wherein none of the one or more bow elements is directly connected to the base section and/or wherein none of the one or more bow elements is completely connected to the base section, and/or wherein one or more gaps are present between each bow element of the one or more bow elements and the base section.

6. The telescopic boom according to claim 1, wherein the support element has a further mount which is configured for attaching the luffing element, wherein the support element is further arranged at least partially on both sides of the base section and/or further at least partially on the upper side of the base section, wherein one of the mounts is provided on one side of the base section on the support element and the other mount is provided on the other side of the base section on the support element.

7. The telescopic boom according to claim 1, wherein each of the one or more bow elements is of box-type construction and/or has an elongated section and two shorter sections angled therefrom.

8. The telescopic boom according to claim 1, wherein both ends of each of the one or more bow elements are connected to the support element.

9. The telescopic boom according to claim 1, wherein at the back and at the front of the support element, in each case multiple ribs extending in the longitudinal direction of the base section are connected, which are also connected to the base section.

10. The telescopic boom according to claim 1, wherein the support element is of box-type construction and/or is fully or partially connected to the base section.

11. The telescopic boom according to claim 1, wherein each mount is arranged in an upper quarter of the base section.

12. The telescopic boom according to claim 1, wherein the support element and each of the one or more bow elements consist of steel plates and are implemented as welded constructions.

13. A crane comprising the telescopic boom according to claim 1.

14. The telescopic boom according to claim 1, wherein the one or more bow elements are two bow elements.

15. The telescopic boom according to claim 6, wherein the further mount is identical to said mount.

16. The telescopic boom according to claim 8, wherein shorter sections of each of the one or more bow elements are connected to the support element.

17. The telescopic boom according to claim 16, wherein the shorter sections are welded to the support element.

18. The telescopic boom according to claim 9, wherein the multiple ribs are each triangular in shape.

19. The telescopic boom according to claim 9, wherein the multiple ribs are connected by welding.

20. The telescopic boom according to claim 10, wherein the support element is fully or partially connected to the base section by welding.
